(19) United States
(12) Patent Application Publication
(10) Pub. No.: US 2019/0148924 A1
(43) Pub. Date: May 16, 2019

(54) WIRE HARNESS

(71) Applicant: Yazaki Corporation, Tokyo (JP)

(72) Inventors: Shugo HARA, Shizuoka (JP); Hidetoshi SATO, Shizuoka (JP); Koji MIYAKOSHI, Shizuoka (JP)

(73) Assignee: Yazaki Corporation, Tokyo (JP)

(21) Appl. No.: 16/181,960

(22) Filed: Nov. 6, 2018

(30) Foreign Application Priority Data
Nov. 10, 2017 (JP) 2017-217550

(51) Int. Cl. H02G 3/04; B60R 16/02; H01B 7/00

(52) U.S. Cl. CPC H02G 3/0406; H02G 3/0462; H01B 7/0045; B60R 16/0215

(57) ABSTRACT

A wire harness WH includes a wiring material, a protector that holds the wiring material, and a binding member that fixes the wiring material to the protector, the binding member includes a band portion wound around the protector and the wiring material and a head portion which is connected to a proximal end of the band portion, has an insertion hole, and locks the band portion inserted into the insertion hole, the protector has an accommodation portion that accommodates the head portion, and the accommodation portion includes a pair of first locking portions facing each other with the band portion interposed therebetween from both sides in a width direction and locking a surface of the head portion connected to a proximal end of the band portion.

### CROSS-REFERENCE TO RELATED APPLICATION(S)

The present application claims priority to and incorporates by reference the entire contents of Japanese Patent Application No. 2017-217550 filed in Japan on Nov. 10, 2017.

### BACKGROUND OF THE INVENTION

### 1. Field of the Invention

The present invention relates to a wire harness.

### 2. Description of the Related Art

Conventionally, there has been a case in which a binding member is attached to a protector. Japanese Patent Application Laid-open No. 2000-161538 discloses a technology of a protector provided with at least one set of a pair of annular protrusions protruding from an outer peripheral portion of the protector and extending in a circumferential direction of the protector. It is regarded that the protector of Japanese Patent Application Laid-open No. 2000-161538 can prevent a band member from being laterally displaced by interposing the band member in the annular protrusions and prevent rotation of the band member by interposing a substrate between front and rear ends of the annular protrusions.

There is room for improvement in suppressing position shift of the binding member with respect to the protector. For example, when a wiring material is fixed to the protector by the binding member, it is desired that rotation of the binding member can be suppressed.

### SUMMARY OF THE INVENTION

A purpose of the present invention is to provide a wire harness that suppresses a relative rotation of a binding member with respect to a protector.

According to an aspect of the present invention, a wire harness includes: a wiring material; a protector that holds the wiring material; and a binding member that fixes the wiring material to the protector. The binding member includes a band portion wound around the protector and the wiring material and a head portion which is connected to a proximal end of the band portion, has an insertion hole, and locks the band portion inserted into the insertion hole, the protector includes an accommodation portion that accommodates the head portion, and the accommodation portion includes a pair of first locking portions facing each other with the band portion interposed therebetween from both sides in a width direction and locking a surface of the head portion connected to a proximal end of the band portion and a pair of second locking portions facing each other with the band portion interposed therebetween from both sides in the width direction and locking a surface of the head portion on which an insertion slot of the insertion hole is formed.

According to another aspect of the present invention, in the wire harness, the protector may include a main wall having a support surface that supports the wiring material and a side wall extending in a direction intersecting the main wall from an end of the support surface in the width direction, the accommodation portion, may include a notch formed from an edge of the side wall over the main wall, and the first locking portions each may be a protrusion formed at an inlet of the notch in the side wall to protrude toward a side surface of the band portion.

According to still another aspect of the present invention, in the wire harness, the protector may include a main wall having a support surface that supports the wiring material and a side wall extending in a direction intersecting the main wall from an end of the support surface in the width direction, the accommodation portion may include a notch formed from an edge of the side wall over the main wall, and the second locking portions each may be a protrusion protruding from a back surface which is a surface of the main wall on an opposite side from the support surface and are disposed adjacent to the notch.

According to still another aspect of the present invention, in the wire harness, the binding member may include an anchor portion fixed to a wall to be fixed, the anchor portion may protrude from the head portion and include a columnar portion locked by being inserted into a hole formed in the wall to be fixed and a pressing portion which is provided at a proximal end of the columnar portion, is elastically deformable, and presses the wall in a state in which the columnar portion is locked, and the second locking portions may be separated from the pressing portion in a state in which the pressing portion is not elastically deformed, and support the pressing portion in the state in which the columnar portion is locked. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire harness according to an embodiment;

FIG. 2 is a side view of a binding member according to the embodiment;

FIG. 3 is a perspective view of the binding member according to the embodiment;

FIG. 4 is a perspective view of a protector according to the embodiment;

FIG. 5 is a side view of the protector according to the embodiment;

FIG. 6 is a front view of the protector according to the embodiment;

FIG. 7 is a front view for description of a winding method of the binding member in the embodiment;

FIG. 8 is a perspective view for description of the winding method of the binding member in the embodiment;

FIG. 9 is a side view for description of the winding method of the binding member in the embodiment; and

FIG. 10 is a cross-sectional view for description of the winding method of the binding member in the embodiment.

### DETAILED DESCRIPTION OF THE PREFERRED EMBODIMENTS

Hereinafter, a wire harness according to an embodiment of the invention will be described in detail with reference to drawings. It should be noted that the invention is not limited by this embodiment. In addition, a constituent element in the embodiment below includes a constituent element that can be easily assumed by those skilled in the art or substantially the same one.

### Embodiment

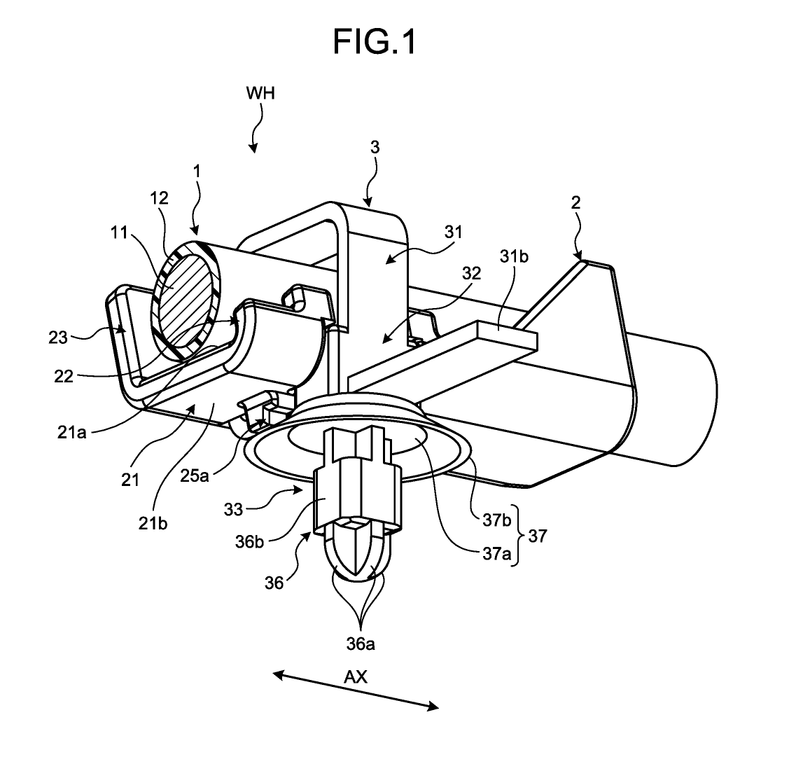

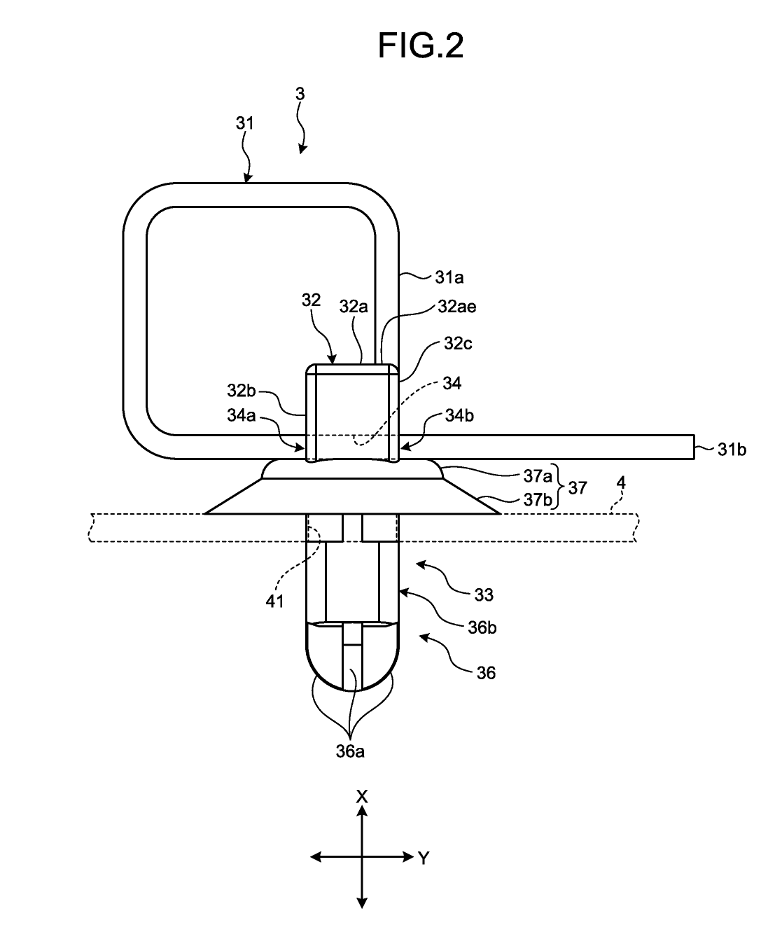

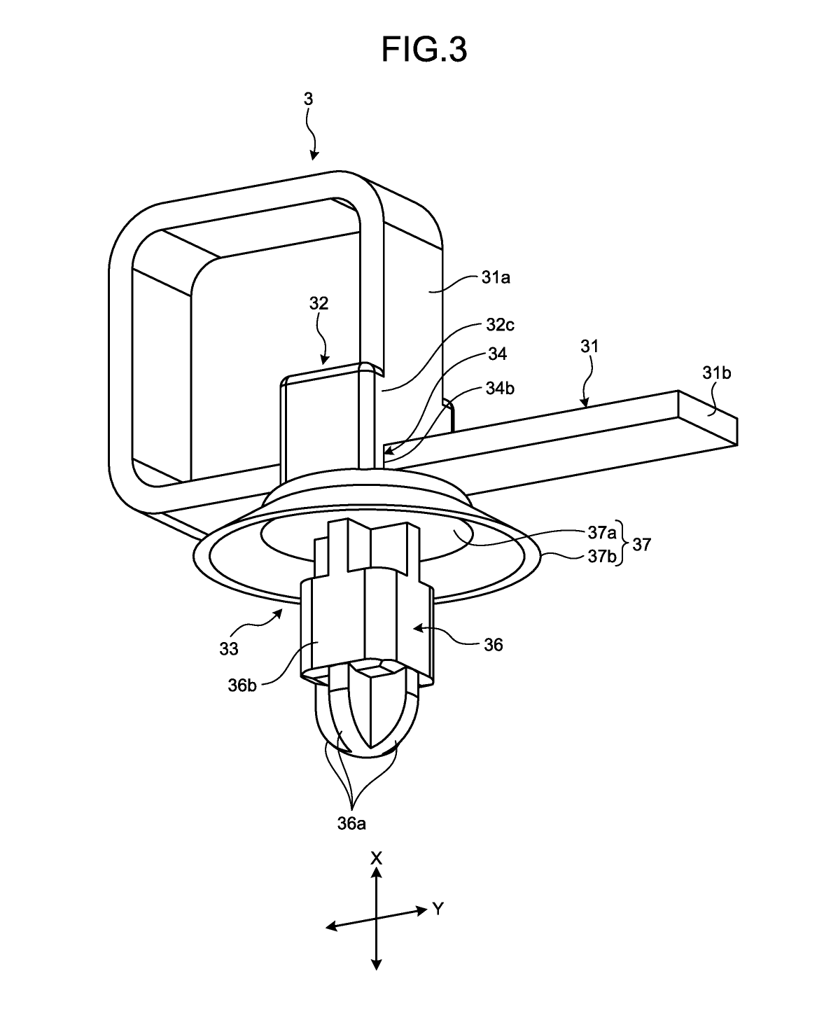

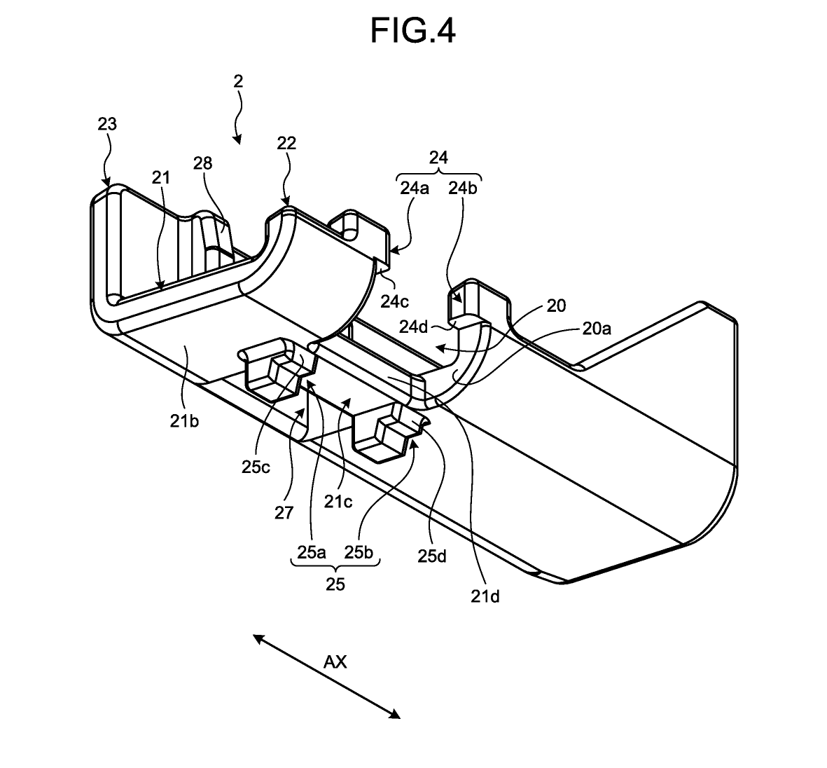

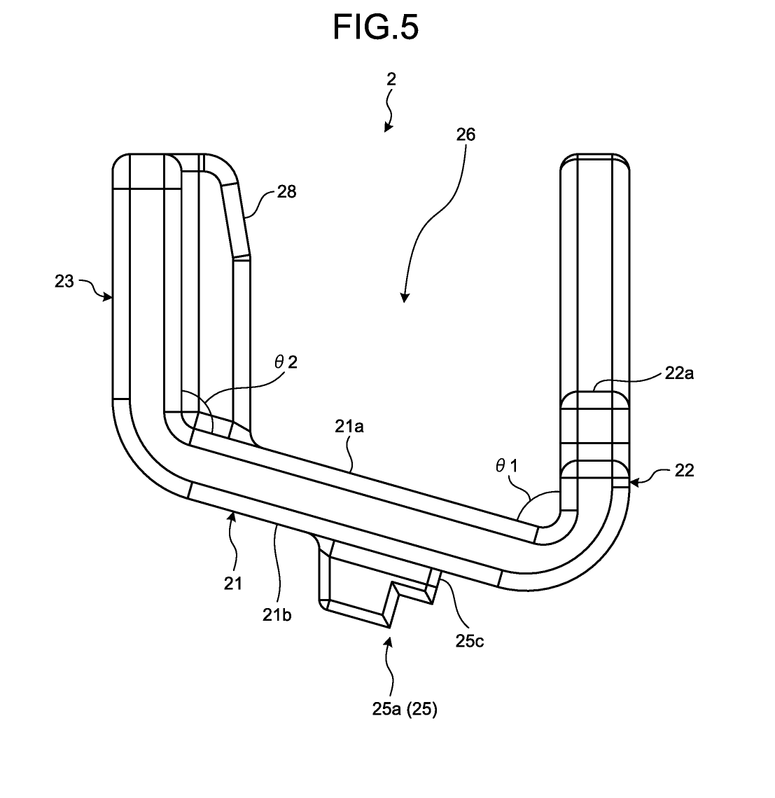

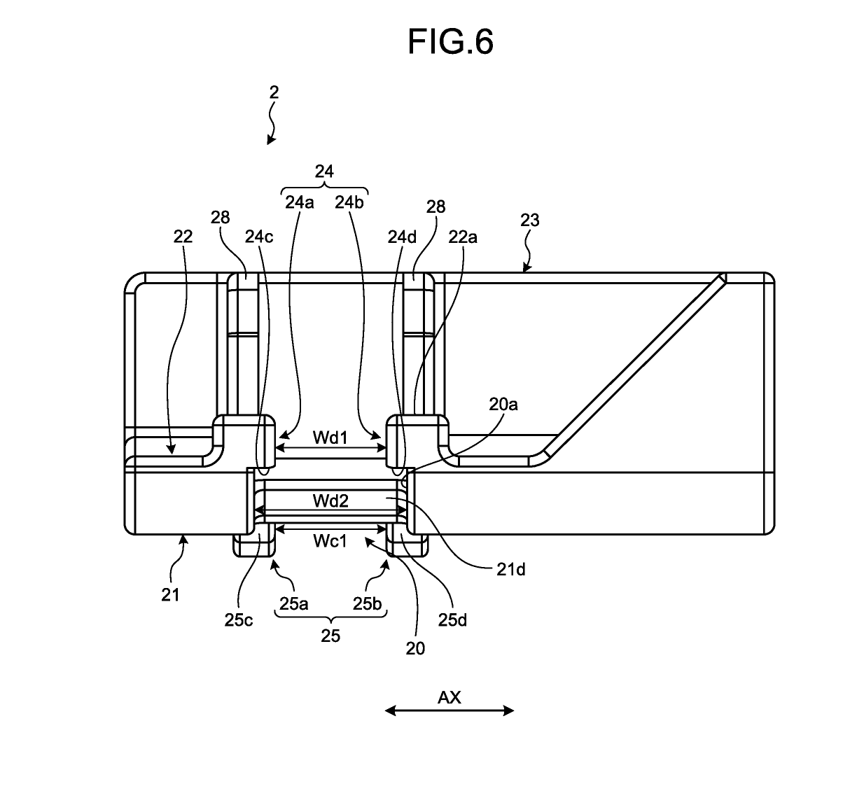

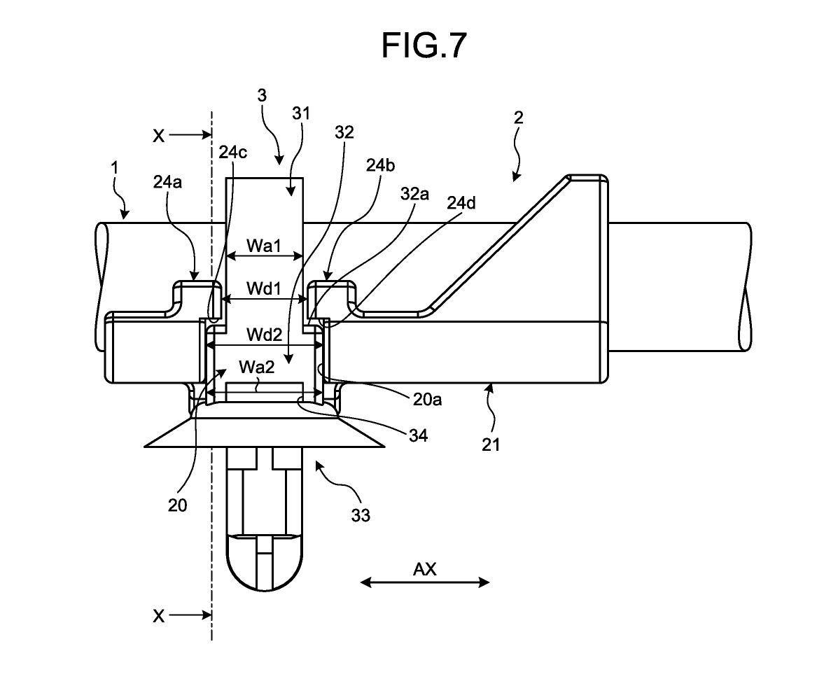

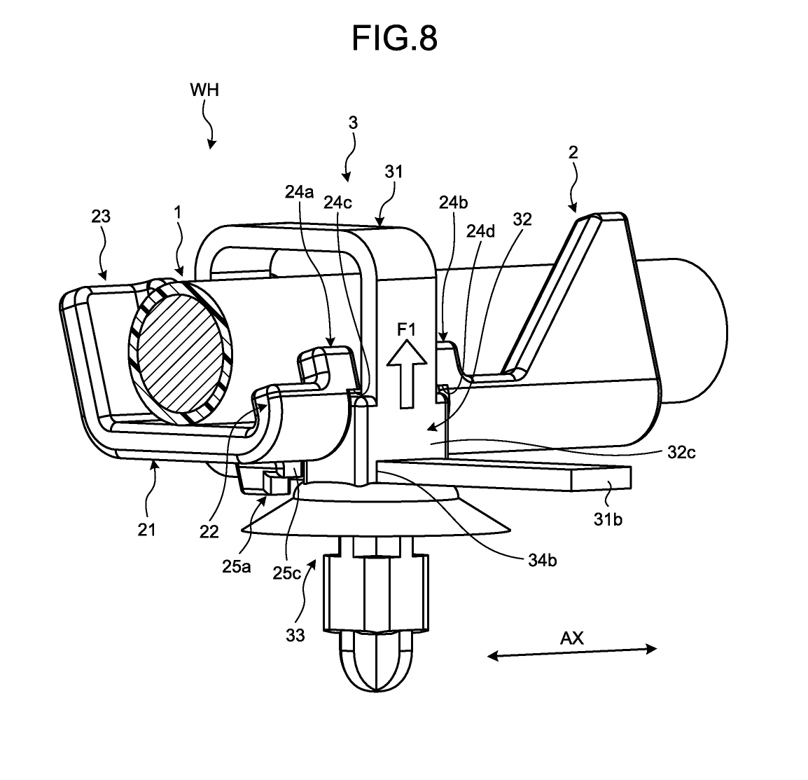

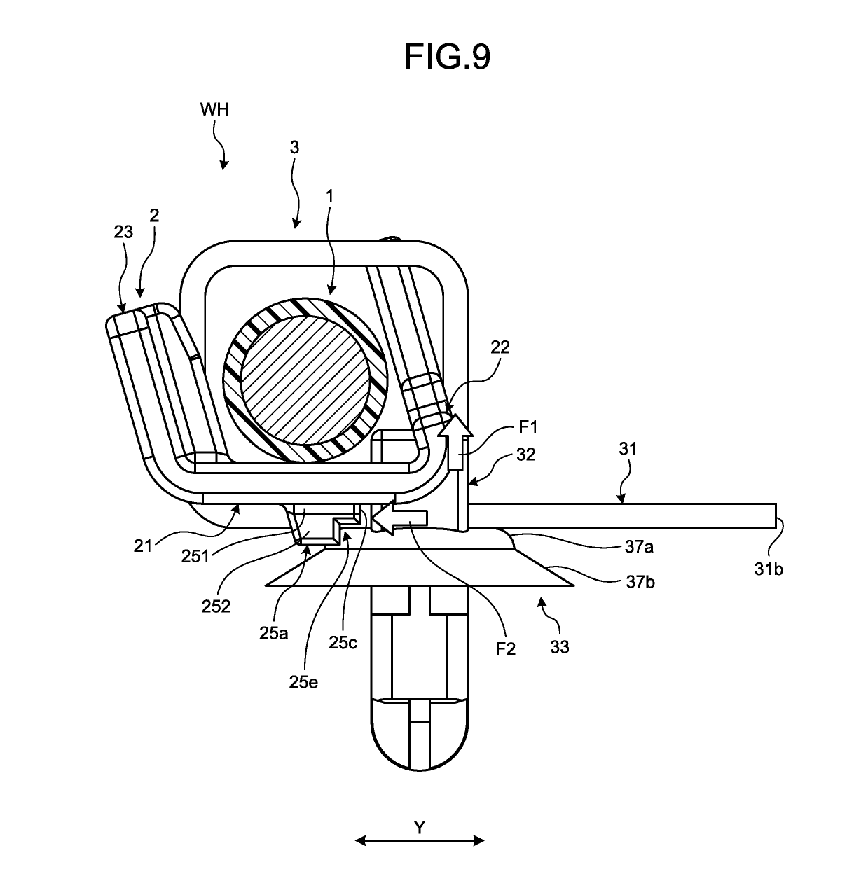

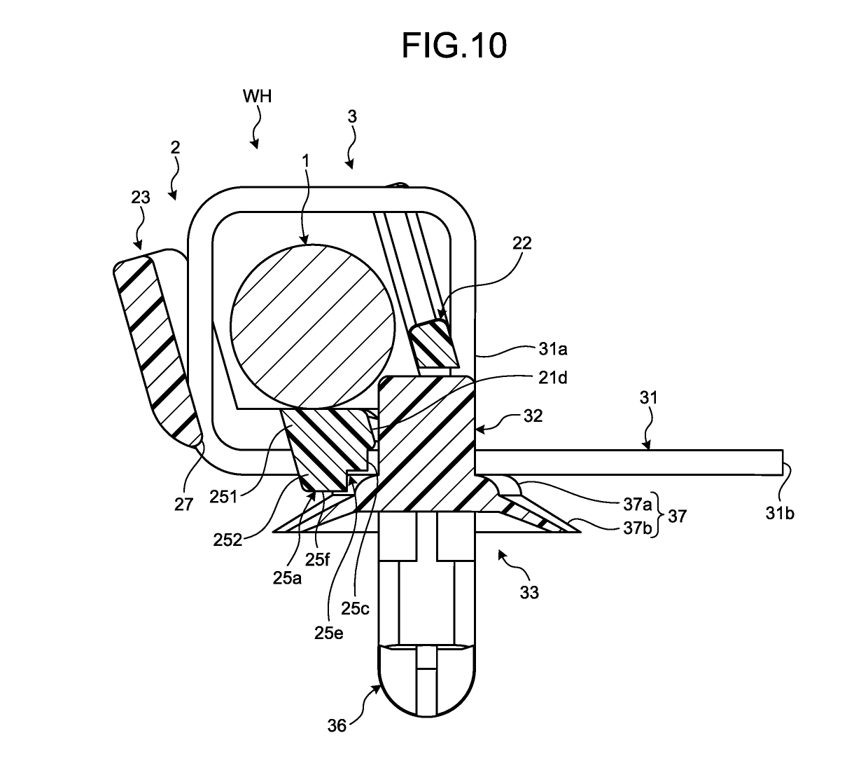

The embodiment will be described with reference to FIG. 1 to FIG. 10. The present embodiment relates to a wire harness. FIG. 1 is a perspective view of the wire harness according to the embodiment, FIG. 2 is a side view of a binding member according to the embodiment, FIG. 3 is a perspective view of the binding member according to the embodiment, FIG. 4 is a perspective view of a protector according to the embodiment, FIG. 5 is a side view of the protector according to the embodiment, FIG. 6 is a front view of the protector according to the embodiment, FIG. 7 is a front view for description of a winding method of the binding member in the embodiment, FIG. 8 is a perspective view for description of the winding method of the binding member in the embodiment, FIG. 9 is a side view for description of the winding method of the binding member in the embodiment, and FIG. 10 is a cross-sectional view for description of the winding method of the binding member in the embodiment. In FIG. 10, an X-X cross section of FIG. 7 is illustrated.

As illustrated in FIG. 1, the wire harness WH according to the embodiment includes a wiring material 1, protector 2, and a binding member 3. The wire harness WH may further include an electrical connection box. In a vehicle such as an automobile, the wire harness WH connects devices mounted in the vehicle. The wire harness WH includes the wiring material 1 used for power supply and signal communication. The number of wiring materials 1 included in the wire harness WH may be one or plural.

The wiring material 1 of the present embodiment is a covered electric wire having a core wire 11 and an insulating coating 12 covering the core wire 11. For example, one end of the wiring material 1 is connected to an electronic component housed in the electrical connection box. For example, the other end of the wiring material 1 is connected to each device (external device) such as a battery or an electrical component via a connector.

The protector 2 is a member that holds the wiring material 1. The protector 2 is formed in a shape corresponding to a wiring path. The protector 2 extends the wiring material 1 along the wiring path and protects the wiring material 1. The protector 2 is formed of, for example, an insulating synthetic resin.

The binding member 3 fixes the wiring material 1 to the protector 2. The binding member 3 of the present embodiment is a member referred to as a so-called band clip. More specifically, the binding member 3 has a band portion 31, a head portion 32, and an anchor portion 33. The band portion 31, the head portion 32, and the anchor portion 33 are integrally formed of an insulating synthetic resin, etc.

The band portion 31 is a constituent portion formed in an elongated flat plate shape. The band portion 31 has flexibility and can be elastically deformed into an arbitrary curved shape. The band portion 31 is wound around and fastened to the wiring material 1 and the protector 2, thereby fixing the wiring material 1 to the protector 2.

The head portion 32 is connected to a proximal end 31a of the band portion 31. A shape of the head portion 32 is, for example, a block shape. The head portion 32 has a wider width than that of the band portion 31 in the width direction of the band portion 31. The shape of the head portion 32 of the present embodiment is a substantially rectangular parallelepiped. The band portion 31 extends from a first surface 32a which is one of a plurality of surfaces of the head portion 32. A shape of the first surface 32a is a rectangle. The band portion 31 extends from an end 32ae of the first surface 32a in a direction orthogonal to the first surface 32a.

As illustrated in FIG. 2 and FIG. 3, the head portion 32 has an insertion hole 34. The insertion hole 34 is a through-hole penetrating the head portion 32 in a direction parallel to the first surface 32a. The insertion hole 34 extends inside the head portion 32 from a second surface 32b to a third surface 32c. The second surface 32b and the third surface 32c are surfaces which are adjacent to the first surface 32a and face opposite to each other. In the binding member 3 of the present embodiment, the second surface 32b and the third surface 32c are orthogonal to the first surface 32a.

The insertion hole 34 has an inlet side opening 34a and an outlet side opening 34b. The inlet side opening 34a is an opening portion of the second surface 32b in the insertion hole 34. The outlet side opening 34b is an opening portion of the third surface 32c in the insertion hole 34. A distal end 31b of the band portion 31 is inserted into the insertion hole 34 from the inlet side opening 34a and protrudes from the outlet side opening 34b. The insertion hole 34 is formed at an end of the head portion 32 on an opposite side from the first surface 32a side. The head portion 32 has a locking mechanism for locking the band portion 31 inserted in the insertion hole 34. For example, the locking mechanism is a claw portion for locking unevenness formed on the band portion 31.

The anchor portion 33 is connected to the end of the head portion 32 on the opposite side from the first surface 32a side. The anchor portion 33 has a columnar portion 36 and a pressing portion 37. The pressing portion 37 has a base portion 37a and a skirt portion 37b. The base portion 37a is a disk-shaped constituent portion. In the following description, the direction orthogonal to the first surface 32a of the head portion 32 will be referred to as an “axial direction X”. In addition, a direction in which the insertion hole 34 extends will be referred to as an “insertion direction Y”. The base portion 37a protrudes in a direction orthogonal to the axial direction X with respect to the head portion 32. An outer diameter of the base portion 37a increases as moving away from the head portion 32 along the axial direction X.

The columnar portion 36 is a constituent portion formed in a columnar shape. The columnar portion 36 protrudes from the head portion 32 along the axial direction X toward a side opposite to the band portion 31 side. The columnar portion 36 has four plate portions 36a orthogonal to each other. The plate portion 36a protrudes in the direction orthogonal to the axial direction X and extends along the axial direction X. Two plate portions 36a protrude in the insertion direction Y. The other two plate portions 36a protrude in a direction orthogonal to the insertion direction Y. A distal end of the plate portion 36a is tapered. A locked portion 36b is formed in an intermediate portion of the columnar portion 36 in the axial direction X. The locked portion 36b is a prismatic constituent component. A cross-sectional shape of the locked portion 36b is substantially rectangular.

The skirt portion 37b is connected to an edge of the base portion 37a. The skirt portion 37b is an elastically deformable plate-shaped constituent portion. A shape of the skirt portion 37b is an annular shape when viewed from the axial direction X. The skirt portion 37b is formed in a skirt shape and is inclined with respect to the axial direction X. More specifically, a diameter of the skirt portion 37b increases as the skirt portion 37b is away from the head portion 32 along the axial direction X.

As illustrated in FIG. 2, the binding member 3 is fixed to a wall 4 of the vehicle. For example, the wall 4 is a panel member made of metal or resin. A hole 41 penetrating the wall 4 is formed in the wall 4. For example, the binding member 3 is fixed to the wall 4 by an operator. The columnar portion 36 of the anchor portion 33 is inserted into the hole 41 from the distal end side. When the columnar portion 36 is inserted deeply into the hole 41, the skirt portion 37b of the pressing portion 37 comes into contact with the wall 4. When the columnar portion 36 is further deeply inserted, the skirt portion 37b is elastically deformed to press the wall 4. The operator inserts the columnar portion 36 into the hole 41 until the locked portion 36b passes through the hole 41 while elastically deforming the skirt portion 37b. The locked portion 36b passing through the hole 41 is locked by the wall 4. When the wall 4 is interposed by the locked portion 36b and the elastically deformed skirt portion 37b, the anchor portion 33 is fixed to the wall 4.

The binding member 3 is attached to the wall 4 in a state in which the wiring material 1 and the protector 2 are fixed. That is, the wire harness WH of the present embodiment is fixed to the wall 4 by the anchor portion 33. In other words, the wiring material 1 and the protector 2 are supported by the wall 4 via the binding member 3. For example, the wire harness WH has a plurality of binding members 3, and anchor portions 33 of the plurality of binding members 3 are fixed to the wall 4, respectively.

As illustrated in FIG. 4 to FIG. 6, the protector 2 has a main wall 21, a first side wall 22, and a second side wall 23. The main wall 21, the first side wall 22, and the second side wall 23 are integrally formed. The main wall 21 is a flat plate-shaped constituent portion and has a support surface 21a that supports the wiring material 1. In the main wall 21, a surface on an opposite side from the support surface 21a side is referred to as a back surface 21b.

The first side wall 22 is connected to an end of the main wall 21 on one side in the width direction. The second side wall 23 is connected to an end of the main wall 21 on the other side in the width direction. The first side wall 22 extends in a direction intersecting the main wall 21 from an end of the support surface 21a on one side in the width direction. The second side wall 23 extends in a direction intersecting the main wall 21 from an end of the support surface 21a on the other side in the width direction.

As illustrated in FIG. 5, the main wall 21, the first side wall 22, and the second side wall 23 form a wiring space 26. The wiring space 26 is a space in which the wiring material 1 is housed, and is surrounded by the main wall 21 and the two side walls 22 and 23. In the protector 2 of the present embodiment, the first side wall 22 is erected with respect to the main wall 21 so that an angle θ1 formed with the main wall 21 becomes an acute angle. The second side wall 23 is erected with respect to the main wall 21 so that an angle θ2 formed with the main wall 21 becomes an obtuse angle. The protector 2 is curved at a connecting portion between the main wall 21 and the two side walls 22 and 23.

As illustrated in FIG. 4, the main wall 21 has a through-hole 27 through which the band portion 31 is inserted. The through-hole 27 penetrates the main wall 21 in a plate thickness direction. The through-hole 27 of the present embodiment is formed at the end of the main wall 21 on the second side wall 23 side. For example, a shape of the through-hole 27 is rectangular. Dimensions of a width and a depth of the through-hole 27 are set to values that allow the band portion 31 of the binding member 3 to be inserted into the through-hole 27. The band portion 31 is inserted into the through-hole 27 from the support surface 21a side.

In description below, an extending direction of the wiring material 1 will be referred to as a “wiring direction AX”. The wiring direction AX is a direction in which the wiring material 1 is wired with respect to the protector 2. As illustrated in FIG. 6, the protector 2 has a pair of guide ribs 28 and 28. The guide ribs 28 and 28 are linear ribs protruding from the second side wall 23 toward the first side wall 22. The guide ribs 28 and 28 guide the band portion 31 to the through-hole 27. The guide ribs 28 and 28 are positioned with the through-hole 27 interposed therebetween in the wiring direction AX.

As illustrated in FIG. 4 and FIG. 6, the protector 2 has an accommodation portion 20. The accommodation portion 20 is configured to accommodate the head portion 32 of the binding member 3 and hold the head portion 32. The accommodation portion 20 includes a notch 20a. The notch 20a is formed an edge 22a of the first side wall 22 over the main wall 21. That is, the notch 20a is formed to divide the first side wall 22 in the wiring direction AX.

In addition, an inner portion of the notch 20a is formed in the main wall 21. The notch 20a is formed at a position adjacent to the through-hole 27 in the width direction of the main wall 21. That is, as illustrated in FIG. 4, the main wall 21 has a pillar 21c interposed between the through-hole 27 and the notch 20a.

The accommodation portion 20 of the present embodiment has a pair of first locking portions 24a and 24b and a pair of second locking portions 25a and 25b. In description below, the pair of first locking portions 24a and 24b may be collectively referred to as a “first locking portion 24”. In addition, the pair of second locking portions 25a and 25b may be collectively referred to as a “second locking portion 25”. The first locking portion 24 and the second locking portion 25 lock the head portion 32 accommodated in the accommodation portion 20 and regulate position shift of the head portion 32. The first locking portion 24 is formed at an inlet of the notch 20a in the first side wall 22. The first locking portion 24 is a protrusion provided on the first side wall 22 and protruding toward the wiring direction AX.

The pair of first locking portions 24a and 24b faces each other in the wiring direction AX. One first locking portion 24a protrudes toward one side in the wiring direction AX, and the other first locking portion 24b protrudes toward the other side in the wiring direction AX. Since the first locking portion 24 is provided, a width Wd1 (see FIG. 6) of an inlet part of the notch 20a is narrower than a width Wd2 of the inner portion of the notch 20a. The width Wd1 of the inlet part is an interval between distal end surfaces of the pair of first locking portions 24a and 24b.

As illustrated in FIG. 7, the width Wd1 of the inlet part is wider than a width Wa1 of the band portion 31 and narrower than a width Wa2 of the head portion 32. That is, an interval (=the width Wd1 of the inlet part) between the pair of first locking portions 24a and 24b is a value that allows passage of the band portion 31 and regulates passage of the head portion 32. Locking surfaces 24c and 24d corresponding to side surfaces of the pair of first locking portions 24a and 24b lock the head portion 32. As can be understood from FIG. 7, etc., the pair of first locking portions 24a and 24b is protrusions protruding toward a side surface of the band portion 31.

In addition, the width Wd2 of the inner portion in the notch 20a is slightly wider than the width Wa2 of the head portion 32. That is, the respective widths Wa1, Wa2, Wd1, and Wd2 have a relationship of the following Formula (1).

Wa1<Wd1<Wa2<Wd2 (1)

The second locking portion 25 is a protrusion protruding from the back surface 21b of the main wall 21. The second locking portion 25 is disposed adjacent to the notch 20a. More specifically, the pair of second locking portions 25a and 25b is formed at both ends of the pillar 21c. That is, as illustrated in FIG. 4, one second locking portion 25a protrudes from one end of the pillar 21c in the wiring direction AX. The other second locking portion 25b protrudes from the other end of the pillar 21c in the wiring direction AX. The pair of second locking portions 25a and 25b has locking surfaces 25c and 25d, respectively. The locking surfaces 25c and 25d correspond to surfaces facing the first side wall 22 side in the second locking portion 25.

An interval Wc1 (see FIG. 6) between the pair of second locking portions 25a and 25b in the wiring direction AX is wider than the width Wa1 of the band portion 31 and narrower than the width Wa2 of the head portion 32. That is, a value of the interval Wc1 between the pair of second locking portions 25a and 25b is as value that allows passage of the band portion 31 and regulates passage of the head portion 32.

A locking surface 21d is formed on a deepest side of the notch 20a. The locking surface 21d is a part of the main wall 21 and faces the width direction of the main wall 21. The locking surface 21d is a side surface of the pillar 21c. The locking surface 21d locks the head portion 32 accommodated in the accommodation portion 20.

A description will be given of a method of fixing the wiring material 1 to the protector 2 with reference to FIG. 7 to FIG. 9. As illustrated in FIG. 7, in a state in which the wiring material 1 is placed on the protector 2, the binding member 3 is wound around the protector 2 and the wiring material 1. In this instance, the head portion 32 of the binding member 3 is accommodated in the accommodation portion 20. More specifically, the head portion 32 is accommodated in the accommodation portion 20 so that the first surface 32a faces the locking surfaces 24c and 24d. The operator accommodates the head portion 32 in the accommodation portion 20 and winds the band portion 31 around the wiring material 1.

In this instance, the operator winds the band portion 31 around the wiring material 1 by passing the band portion 31 through a gap between the pair of first locking portions 24a and 24b. When the head portion 32 is accommodated in the accommodation portion 20, positioning of the band portion 31 in the wiring direction AX is performed. The band portion 31 is positioned at a location facing the gap between the pair of first locking portions 24a and 24b. Therefore, the operator may pass the band portion 31 through the gap between the pair of first locking portions 24a and 24b merely by winding the band portion 31 around the wiring material 1. The pair of first locking portions 24a and 24b may support the band portion 31 from both sides in the wiring direction AX and regulate position shift of the band portion 31.

The operator inserts the distal end 31b of the band portion 31 wound around the wiring material 1 into the through-hole 27. The distal end 31b protrudes from the through-hole 27 to the back surface 21b side of the main wall 21. As illustrated in FIG. 8 and FIG. 9, the operator inserts the distal end 31b of the band portion 31 into the insertion hole 34 of the head portion 32. The distal end 31b of the band portion 31 protrudes from the outlet side opening 34b of the insertion hole 34. The operator draws a part of the band portion 31 on the distal end 31b side from the insertion hole 34 and fastens the band portion 31. A fastening operation of the band portion 31 may be performed using a tool, etc. As the band portion 31 is fastened, the band portion 31 enters the gap between the pair of second locking portions 25a and 25b. The pair of second locking portions 25a and 25b may support the band portion 31 from both sides in the wiring direction AX and regulate position shift of the band portion 31.

Due to the fastening operation of the band portion 31, a force in two directions acts on the head portion 32. As illustrated in FIG. 9, when the band portion 31 is fastened to the wiring material 1 and the protector 2, a first force F1 and a second force F2 act on the head portion 32. The first force F1 is a force in a direction in which the proximal end 31a of the band portion 31 pulls the head portion 32. The head portion 32 is pressed toward the locking surfaces 24c and 24d of the protector 2 by the first force F1. The locking surfaces 24c and 24d lock the head portion 32 to regulate rotation of the binding member 3.

The second force F2 is a force acting on the head portion 32 from the band portion 31 inserted into the through-hole 27. In other words, the second force F2 is a force corresponding to a locking force with which the head portion 32 locks the band portion 31. The second force F2 is a force in a direction in which the band portion 31 is drawn from the head portion 32. The head portion 32 is pressed toward the locking surface 21d and the second locking portion 25 of the protector 2 by the second force F2. The locking surface 21d and the second locking portion 25 lock the head portion 32 to regulate rotation of the binding member 3.

When the wiring material 1 is fixed to the protector 2 by the binding member 3, the wire harness WH is completed. The wire harness WH is fixed to the wall 4 by the anchor portion 33 of the binding member 3. Here, the first force F1 or the second force F2 may act on the head portion 32 until the wire harness WH is attached to the wall 4. For example, when the wire harness WH is conveyed, the first force F1 or the second force F2 may act on the head portion 32 due to contact with another component, etc. When the binding member 3 rotates due to the first force F1 or the second force F2, a position of the anchor portion 33 is shifted, and there is a possibility that the wire harness WH may not be fixed to the wall 4. Alternatively, there is a possibility that an attachment angle or an attachment position of the wire harness WH with respect to the wall 4 may be different from a desired angle or position.

After the wire harness WH is fixed to the wall 4, the first force F1 or the second force F2 may act on the head portion 32. For example, the first force F1 or the second force F2 acts on the head portion 32 due to vibration, etc. generated while the vehicle is driven. When the binding member 3 rotates due to the first force F1 or the second force F2, a fixed position of the wire harness WH with respect to the wall 4 or a posture of the wire harness WH changes. It is desired to be able to suppress position shift of the head portion 32 and the anchor portion 33.

The wire harness WH of the present embodiment has the pair of first locking portions 24a and 24b locking the first surface 32a of the head portion 32. The pair of first locking portions 24a and 24b faces each other with the band portion 31 interposed therebetween from both sides in the width direction. Therefore, the first locking portion 24 may appropriately lock the head portion 32 against the first force F1 acting on the head portion 32 from the band portion 31. For example, the first locking portion 24 may lock the head portion 32 while suppressing generation of a rotational moment due to the first force F1 with respect to the head portion 32. Therefore, the first locking portion 24 may regulate relative rotation of the binding member 3 with respect to the wiring material 1 and the protector 2. As a result, the first locking portion 24 may appropriately maintain the fixed position of the wire harness WH with respect to the wall 4 and the posture of the wire harness WH.

The wire harness WH of the present embodiment has the pair of second locking portions 25a and 25b locking the second surface 32b of the head portion 32. The pair of second locking portions 25a and 25b faces each other with the band portion 31 interposed therebetween from both sides in the width direction. Therefore, the second locking portion 25 may appropriately lock the head portion 32 against the second force F2 acting on the head portion 32 from the band portion 31. For example, the second locking portion 25 may lock the head portion 32 while suppressing generation of a rotational moment due to the second force F2 with respect to the head portion 32. Therefore, the second locking portion 25 may regulate relative rotation of the binding member 3 with respect to the wiring material 1 and the protector 2. As a result, the second locking portion 25 may appropriately maintain the fixed position of the wire harness WH with respect to the wall 4 and the posture of the wire harness WH.

In addition, the second locking portion 25 of the present embodiment is configured to have difficulty in disturbing deformation of the skirt portion 37b when the anchor portion 33 is fixed to the wall 4. Specifically, as illustrated in FIG. 9, etc., the second locking portion 25 has a stepped portion 25e. The second locking portion 25 has a proximal end 251 and a distal end 252. The proximal end 251 is a constituent portion on the main wall 21 side. The distal end 252 protrudes toward an opposite side from the main wall 21 from the proximal end 251. A width of the distal end 252 along the insertion direction Y is narrower than a width of the proximal end 251. The distal end 252 is formed at a position of the proximal end 251 on the second side wall 23 side. That is, the second locking portion 25 has the stepped portion 25e on the first side wall 22 side. A shape of the stepped portion 25e corresponds to a shape of the base portion 37a of the pressing portion 37.

As illustrated in FIG. 10, when the stepped portion 25e is provided, a gap is formed between the base portion 37a and the skirt portion 37b, and the second locking portion 25. Therefore, when the anchor portion 33 is attached to the wall 4, it is difficult for the second locking portion 25 to disturb deformation of the skirt portion 37b. In other words, the skirt portion 37b and the second locking portion 25 rarely interfere with each other. Therefore, the second locking portion 25 of the present embodiment is less likely to affect workability of an installation operation of the wire harness WH on the wall 4.

In addition, the second locking portion 25 can lock the base portion 37a and the skirt portion 37b after the wire harness WH is fixed to the wall 4. For example, when the second force F2 acts on the head portion 32, not only the head portion 32 but also the base portion 37a and the skirt portion 37b can be locked to regulate rotation of the binding member 3. The second locking portion 25 may be configured to come into contact with the skirt portion 37b in a state in which the wire harness WH is fixed to the wall 4 and the skirt portion 37b is elastically deformed. As an example, in a state in which the skirt portion 37b is elastically deformed, a distal end surface 25f of the second locking portion 25 may come into contact with the skirt portion 37b.

As described above, the wire harness WH according to the present embodiment includes the wiring material 1, the protector 2, and the binding member 3. The protector 2 is a member that holds the wiring material 1. The binding member 3 fixes the wiring material 1 to the protector 2. The binding member 3 has the band portion 31 and the head portion 32. The band portion 31 is wound around the protector 2 and the wiring material 1. The head portion 32 is connected to the proximal end 31a of the band portion 31 and has the insertion hole 34. The head portion 32 locks the band portion 31 inserted into the insertion hole 34.

The protector 2 has the accommodation portion 20 that accommodates the head portion 32. The accommodation portion 20 has the pair of first locking portions 24a and 24b and the pair of second locking portions 25a and 25b. The pair of first locking portions 24a and 24b faces each other with the band portion 31 interposed therebetween from both sides in the width direction. The pair of first locking portions 24a and 24b locks the first surface 32a of the band portion 31 in the head portion 32. The first surface 32a is a surface connected to the proximal end 31a in the head portion 32.

The pair of second locking portions 25a and 25b faces each other with the band portion 31 interposed therebetween from both sides in the width direction. The pair of second locking portions 25a and 25b locks the second surface 32b in the head portion 32. The second surface 32b is a surface in which the inlet side opening 34a of the insertion hole 34 in the head portion 32 is formed.

In the wire harness WH of the present embodiment, the pair of first locking portions 24a and 24b locks the first surface 32a of the head portion 32, and the pair of second locking portions 25a and 25b locks the second surface 32b of the head portion 32. When each of the first surface 32a and the second surface 32b of the head portion 32 is locked, relative rotation of the binding member 3 with respect to the wiring material 1 and the protector 2 is regulated. In other words, in a state in which the binding member 3 fixes the wiring material 1 to the protector 2 (hereinafter simply referred to as a “fixed state”), position shift of the binding member 3 is regulated. In the wire harness WH according to the present embodiment, when position shift of the head portion 32 is regulated, interference between the head portion 32 and another component hardly occurs. In addition, when position shift of the binding member 3 is regulated, position shift of the wiring material 1 or loosening of the binding member 3 hardly occurs.

In addition, in the wire harness WH of the present embodiment, each of the pair of first locking portions 24a and 24b and the pair of second locking portions 25a and 25b faces each other with the band portion 31 interposed therebetween. Therefore, position shift of the head portion 32 is appropriately regulated with respect to the forces F1 and F2 acting on the head portion 32 from the band portion 31.

In the wire harness WH of the present embodiment, position shift of the head portion 32 is regulated by accommodating the head portion 32 in the accommodation portion 20. Therefore, it is unnecessary to provide a particular configuration for regulating relative rotation in the head portion 32, and it is possible to use the existing binding member 3.

The protector 2 of the present embodiment has the main wall 21 and the first side wall 22. The main wall 21 is a wall having the support surface 21a that supports the wiring material 1. The first side wall 22 is a side wall that extends in a direction intersecting the main wall 21 from the end of the support surface 21a in the width direction. The accommodation portion 20 includes the notch 20a formed from the edge over the main wall 21 in the first side wall 22. The first locking portion 24 is formed at the inlet of the notch 20a in the first side wall 22. The first locking portion 24 is a protrusion that protrudes from the first side wall 22 toward the side surface of the band portion 31.

When the first locking portion 24 is formed by the protrusion formed at the inlet of the notch 20a, an operation of attaching the binding member 3 to the protector 2 is facilitated. For example, workability of an operation of accommodating the head portion 32 in the accommodation portion 20 or an operation of winding the band portion 31 around the wiring material 1 is improved. The operator may easily wind the band portion 31 around the wiring material 1 through the gap between the pair of first locking portions 24a and 24b. As a comparative example, there is a configuration in which two insertion holes for the band portion 31 are provided in the protector 2, and the band portion 31 should be inserted into each of the two insertion holes. For example one of the two insertion holes is provided for positioning of the head portion 32.

In this comparative example, an operation of inserting the distal end 31b of the band portion 31 into the insertion hole occurs twice. On the other hand, in the wire harness WH of the present embodiment, besides inserting the band portion 31 into the through-hole 27, an operation of inserting the distal end 31b of the band portion 31 into the protector 2 is unnecessary. Therefore, according to the wire harness WH of the present embodiment, workability of an operation of fixing the wiring material 1 to the protector 2 by the binding member 3 is improved.

In addition, the operator may accommodate the head portion 32 in the accommodation portion 20 and position the head portion 32 with respect to the protector 2 merely by inserting the band portion 31 between the pair of first locking portions 24a and 24b. Therefore, according to the wire harness WH of the present embodiment, workability of the operation of fixing the wiring material 1 to the protector 2 by the binding member 3 is improved.

The second locking portion 25 of the present embodiment is a protrusion protruding from the back surface 21b and is disposed adjacent to the notch 20a. The back surface 21b is a surface of the main wall 21 on the opposite side from the support surface 21a. When the second locking portion 25 is formed by the protrusion protruding from the back surface 21b, the head portion 32 can be fixed to the back surface 21b side of the protector 2. When the head portion 32 is fixed to the back surface 21b side, interference between the head portion 32 and another component hardly occurs.

The binding member 3 of the present embodiment further includes the anchor portion 33 fixed to the wall 4 to be fixed. The anchor portion 33 has the columnar portion 36 and the pressing portion 37. The columnar portion 36 protrudes from the head portion 32 and is inserted into and locked in the hole 41 formed in the wall 4. The pressing portion 37 is provided at the proximal end of the columnar portion 36 and is elastically deformable. The pressing portion 37 presses the wall 4 in a state in which the columnar portion 36 is locked.

The second locking portion 25 is separated from the pressing portion 37 in a state in which the pressing portion 37 is not elastically deformed. Meanwhile, the second locking portion 25 supports the pressing portion 37 in a state in which the columnar portion 36 is locked. The second locking portion 25 of the present embodiment has a two-stage configuration of the proximal end 251 and the distal end 252. According to this two-stage configuration, it is possible to regulate position shift of the head portion 32 while suppressing the interference of the second locking portion 25 with respect to the elastically deformed pressing portion 37.

In addition, in a state in which the columnar portion 36 is locked, the distal end 252 can support the pressing portion 37. For example, the second locking portion 25 may support the pressing portion 37 by bringing the distal end surface 25f into contact with the skirt portion 37b. Alternatively, the second locking portion 25 may be configured so that the distal end surface 25f faces the skirt portion 37b with a slight gap therebetween in a state in which the columnar portion 36 is locked. When the second locking portion 25 supports the pressing portion 37 in addition to the head portion 32, position shift of the binding member 3 is more reliably regulated.

The stepped portion 25e of the second locking portion 25 can also lock the base portion 37a of the pressing portion 37. For example, in a state in which the wire harness WH is fixed to the wall 4, there is a possibility that a force to rotate the protector 2 relative to the binding member 3 due to an own weight may be applied. In this case, the stepped portion 25e may lock the base portion 37a, thereby regulating relative rotation.

### Modification of Embodiment

A description will be given of a modification of the embodiment. Arrangement and a shape of the accommodation portion 20 are not limited to the illustrated arrangement and shape. In addition, arrangement and shapes of the first locking portion 24 and the second locking portion 25 are not limited to the illustrated arrangement and shapes. The binding member 3 may not have the anchor portion 33.

Contents disclosed in the above embodiment and modification may be appropriately combined and executed.

A wire harness according to the embodiment includes a wiring material, a protector that holds the wiring material, and a binding member that fixes the wiring material to the protector. The binding member includes a band portion wound around the protector and the wiring material and a head portion which is connected to a proximal end of the band portion, has an insertion hole, and locks the band portion inserted into the insertion hole. The protector has an accommodation portion that accommodates the head portion.

The accommodation portion has a pair of first locking portions which faces each other with the band portion interposing therebetween from both sides in a width direction and locks a surface of the head portion connected to the proximal end of the band portion, and a pair of second locking portions which faces each other with the band portion interposing therebetween from both sides in the width direction and locks a surface of the head portion in which an insertion slot of the insertion hole is formed. The wire harness of the invention has an effect that relative rotation of the binding member can be suppressed by locking two surfaces of the head portion using two locking portions.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a wiring material;
a protector that holds the wiring material; and
a binding member that fixes the wiring material to the protector, wherein
the binding member includes a band portion wound around the protector and the wiring material and a head portion which is connected to a proximal end of the band portion, has an insertion hole, and locks the band portion inserted into the insertion hole,
the protector includes an accommodation portion that accommodates the head portion, and
the accommodation portion includes a pair of first locking portions facing each other with the band portion interposed therebetween from both sides in a width direction and locking a surface of the head portion connected to a proximal end of the band portion and a pair of second locking portions facing each other with the band portion interposed therebetween from both sides in the width direction and locking a surface of the head portion on which an insertion slot of the insertion hole is formed.

2. The wire harness according to claim 1, wherein
the protector includes a main wall having a support surface that supports the wiring material and a side wall extending in a direction intersecting the main wall from an end of the support surface in the width direction,
the accommodation portion includes a notch formed from an edge of the side wall over the main wall, and
the first locking portions each is a protrusion formed at an inlet of the notch in the side wall to protrude toward a side surface of the band portion.

3. The wire harness according to claim 1, wherein
the protector includes a main wall having a support surface that supports the wiring material and a side wall extending in a direction intersecting the main wall from an end of the support surface in the width direction,
the accommodation portion includes a notch formed from an edge of the side wall over the main wall, and
the second locking portions each is a protrusion protruding from a back surface which is a surface of the main wall on an opposite side from the support surface and are disposed adjacent to the notch.

4. The wire harness according to claim 2, wherein
the protector includes a main wall having a support surface that supports the wiring material and a side wall extending in a direction intersecting the main wall from an end of the support surface in the width direction,
the accommodation portion includes a notch formed from an edge of the side wall over the main wall, and
the second locking portions each is a protrusion protruding from a back surface which is a surface of the main wall on an opposite side from the support surface and are disposed adjacent to the notch.

5. The wire harness according to claim 1, wherein
the binding member includes an anchor portion fixed to a wall to be fixed,
the anchor portion includes a columnar portion protruding from the head portion and locked by being inserted into a hole formed in the wall to be fixed and a pressing portion which is provided at a proximal end of the columnar portion, is elastically deformable, and presses the wall in a state in which the columnar portion is locked, and
the second locking portions are separated from the pressing portion in a state in which the pressing portion is not elastically deformed, and support the pressing portion in the state in which the columnar portion is locked.

6. The wire harness according to claim 2, wherein
the binding member includes an anchor portion fixed to a wall to be fixed,
the anchor portion protrudes from the head portion and includes a columnar portion locked by being inserted into a hole formed in the wall to be fixed and a pressing portion which is provided at a proximal end of the columnar portion, is elastically deformable, and presses the wall in a state in which the columnar portion is locked, and
the second locking portions are separated from the pressing portion in a state in which the pressing portion is not elastically deformed, and support the pressing portion in the state in which the columnar portion is locked.

7. The wire harness according to claim 3, wherein
the binding member includes an anchor portion fixed to a wall to be fixed,
the anchor portion protrudes from the head portion and includes a columnar portion locked by being inserted into a hole formed in the wall to be fixed and a pressing portion which is provided at a proximal end of the columnar portion, is elastically deformable, and presses the wall in a state in which the columnar portion is locked, and
the second locking portions are separated from the pressing portion in a state in which the pressing portion is not elastically deformed, and support the pressing portion in the state in which the columnar portion is locked.

8. The wire harness according to claim 4, wherein
the binding member includes an anchor portion fixed to a wall to be fixed,
the anchor portion protrudes from the head portion and includes a columnar portion locked by being inserted into a hole formed in the wall to be fixed and a pressing portion which is provided at a proximal end of the columnar portion, is elastically deformable, and presses the wall in a state in which the columnar portion is locked, and
the second locking portions are separated from the pressing portion in a state in which the pressing portion is not elastically deformed, and support the pressing portion in the state in which the columnar portion is locked.
